(19) United States
(12) Patent Application Publication
(10) Pub. No.: US 2016/0082924 A1
(43) Pub. Date: Mar. 24, 2016

(54) STEERING WHEEL LOCK

(71) Applicant: THYSSENKRUPP PRESTA AG, Eschen (LI)

(72) Inventors: Sascha FRICKE, Altstätten (CH); Thomas GEISELBERGER, Nendeln (LI); Martin FLEISCHER, Balgach (CH); Johannes GANAHL, Schruns (AT)

(73) Assignee: THYSSENKRUPP PRESTA AG, Eschen (LI)

(21) Appl. No.: 14/891,647

(22) PCT Filed: Mar. 15, 2014
(86) PCT No.: PCT/EP2014/000695

§ 371 Date: Nov. 16, 2015

(30) Foreign Application Priority Data
May 15, 2013 (DE) 10 2013 104 991.5

(51) Int. Cl. B60R 25/0215

(52) U.S. Cl. CPC B60R 25/0215

(57) ABSTRACT

“Example steering-wheel locks may include a key receptacle for receiving a key in an insertion direction and at least one electrical switch to be actuated upon insertion of the key into the key receptacle in the insertion direction. The at least one electrical switch may include a switching element that is displaceable in at least one switching direction. Moreover, the steering-wheel lock may further include at least one blocking device for selectively blocking a steering spindle, the at least one blocking device being selectively actuatable by the key. The insertion direction and the at least one switching direction are positioned at an angle relative to one another, which in many cases is oblique.”

The present invention relates to a steering-wheel lock with a key receptacle into which a key can be inserted in an insertion direction, and with at least one electrical switch which can be actuated by insertion of the key into the key receptacle in the insertion direction, and with at least one blocking device, which can be actuated by means of the key inserted into the key receptacle, for blocking a steering spindle, wherein the electrical switch exhibits a switching element which is displaceable in at least one switching direction.

Steering-wheel locks are known in numerous configurations in the state of the art. They serve, on the one hand, to block the steering spindle in a locked position by means of their blocking device, so that no steering movements are possible. In modern vehicles there are also steering-wheel locks that provide for the blocking of the steering spindle indirectly, for example via an electrical locking system which acts directly on the steering gear. But, on the other hand, modern steering-wheel locks also exhibit at least one electrical switch. The latter is frequently used for supplying certain circuits of the motor vehicle with current already when the key is inserted into the lock, and for switching these circuits off again only when the key is taken out. Such electrical switches may, for example, be utilized for switching the power supply for the car radio on and off independently of the ignition of the motor vehicle.

From DE 102 62 210 B4 a steering-wheel lock is known in which the electrical switch is arranged in a type of extension of the steering-wheel lock in the insertion direction. In the case of the steering-wheel lock shown therein, the insertion direction and the switching direction consequently coincide. The disadvantage of this is a relatively large overall length of the steering-wheel lock. In addition, there is no particularly great flexibility in the manner in which this steering-wheel lock can be installed in the vehicle.

The object of the invention is to improve a steering-wheel lock of the aforementioned type to the effect that the stated disadvantages are eliminated.

This is achieved in the invention by means of a steering-wheel lock as claimed in claim 1.

Consequently there is provision that the insertion direction and the switching direction are angled in relation to one another.

According to the invention there is consequently provision that the insertion direction and the switching direction no longer coincide or are no longer arranged at a 0° angle and also no longer at an integral multiple of 180° and also not parallel to one another. Rather, the insertion direction and the switching direction are angled in relation to one another. In this connection it may be a question, for example, of an acute angle of less than 90°. Particularly preferred configurations provide that the insertion direction and the switching direction are arranged orthogonally in relation to one another.

Surprisingly, it has turned out that, despite the angled arrangement of insertion direction and switching direction, a trouble-free functioning of the steering-wheel lock without tilting or jamming is possible.

By virtue of the invention, a shorter physical size of the steering-wheel lock overall becomes possible. In addition to this, it is also possible to fit the steering-wheel lock in relatively many positions and orientations, differing from one another, in the instrument panel or directly on the steering-column of the motor vehicle.

In any case, the key receptacle is, as known as such, the channel into which the key is inserted in the insertion direction. It may be a question of extremely diverse types of key. Suitable keys may for example, as known as such, exhibit a bit, in which case an individual access control is possible by virtue of the individual design of the bit, inasmuch as only a defined shape of the bit is suitable to close the steering-wheel lock. But steering-wheel locks are also known in the state of the art in which the key no longer exhibits any bit at all. Here the access control is regulated via electronic components. These keys can usually be inserted, entirely or partly, into a corresponding key receptacle of the steering-wheel lock. Steering-wheel locks according to the invention are also suitable for the design for such keys.

Steering-wheel locks according to the invention make it possible that in the case of a key that has already been inserted into the key receptacle but has not yet actuated the ignition or the blocking device, the electrical switch has already been switched. By this means, prior to the actual start of the motor vehicle and also after the engine has been switched off, electrical circuits can be activated or remain activated without the engine running or the ignition having been switched on, and also without the blocking device releasing the steering spindle. With such circuits, the radio, for example, can already be put into operation, even though the engine is not yet running or the ignition has not yet been switched on. The invention can also be utilized to allow a car radio to continue to work, even though the engine or the ignition has already been switched off. The radio is then switched off by means of the electrical switch only when the key is withdrawn from the key receptacle. The blocking device can be actuated by rotating the key inserted into the key receptacle around the insertion direction, in order to block the steering spindle or to cancel this blocking.

But there may also be provision that the rearranging of the blocking device between its blockade position and its release position is effected by movement of the key in the insertion direction or at least parallel to the insertion direction. The same holds for the switching of the ignition on and off and for the starting or switching-off of the engine. But, above all, it should be pointed out that the blocking device does not necessarily need to be designed to act purely mechanically or directly on the steering spindle. It is also conceivable and possible to produce the rearranging of the blocking device between its blockade position and its release position, and conversely, by electrical means or otherwise indirectly or by interposing further components or actuators, for example also by direct action on the steering gear. In this case, additional electrical switching functions—such as, for example, the starting of the vehicle—can also be realized.

Particularly preferred configurations provide for the interaction of the actuating element and of the switching element for a switching contact of the electrical switch via an inclined surface. For this purpose there is preferably provision that the steering-wheel lock exhibits an actuating element which is moved jointly in the insertion direction when the key is inserted into the key receptacle, at least on sections of this insertion movement, in which case the actuating element acts on the switching element via at least one inclined surface arranged obliquely in relation to the insertion direction and/or in relation to the switching direction. ‘Oblique’ in this connection are all angles that are neither 0° nor integral multiples of 90°. In this connection the inclined surface does not have to be formed flat. It may also be formed as a vaulted convex or concave surface. In this connection, preferred configurations of the invention provide that the inclined surface has been formed as a conical shell, at least in some regions. This is particularly favorable when the key, together with the key receptacle, is rotated in the steering-wheel lock around the insertion direction in order to actuate the blocking device, the ignition or such like. As a rule, a complete conical shell is not necessary in this connection. A formation of the inclined surface as a conical shell in some regions usually suffices. In this connection, the contour in the form of a conical shell may also diverge from the pure conical shape and may exhibit a vaulted concave or convex surface.

The contact region of the actuating element or of the switching element interacting with the inclined surface is favorably rounded, at least in some regions. In principle, the inclined surface may be both part of the actuating element and part of the switching element. However, preferred configurations provide that the inclined surface is part of the actuating element or is at least moved jointly with the latter in the insertion direction. It is also preferred if the contact region is part of the switching element or is at least moved jointly with the latter in the switching direction. The switching element may be configured in highly variable manner. A pin-shaped design of the switching element is preferred. It is also preferred if the insertion direction and/or the switching direction are designed to be exclusively linear.

For the question of how the blocking device is designed, there are extremely diverse possibilities. Preferred variants provide that a blocking bolt of the blocking device is displaceable in such a way that in an engagement position it positively engages into the steering spindle, and in a release position it releases the steering spindle. In this context, particularly preferred variants of the invention provide that the blocking device for blocking the steering spindle exhibits at least one blocking bolt, which is displaceable by means of a cam which is supported to be rotatable, for engaging into the steering spindle. Of course, blocking devices functioning by frictional resistance are also possible.

An embodiment according to the invention is explained in detail in the following description of the figures for the purpose of illustrating the invention. Shown are:

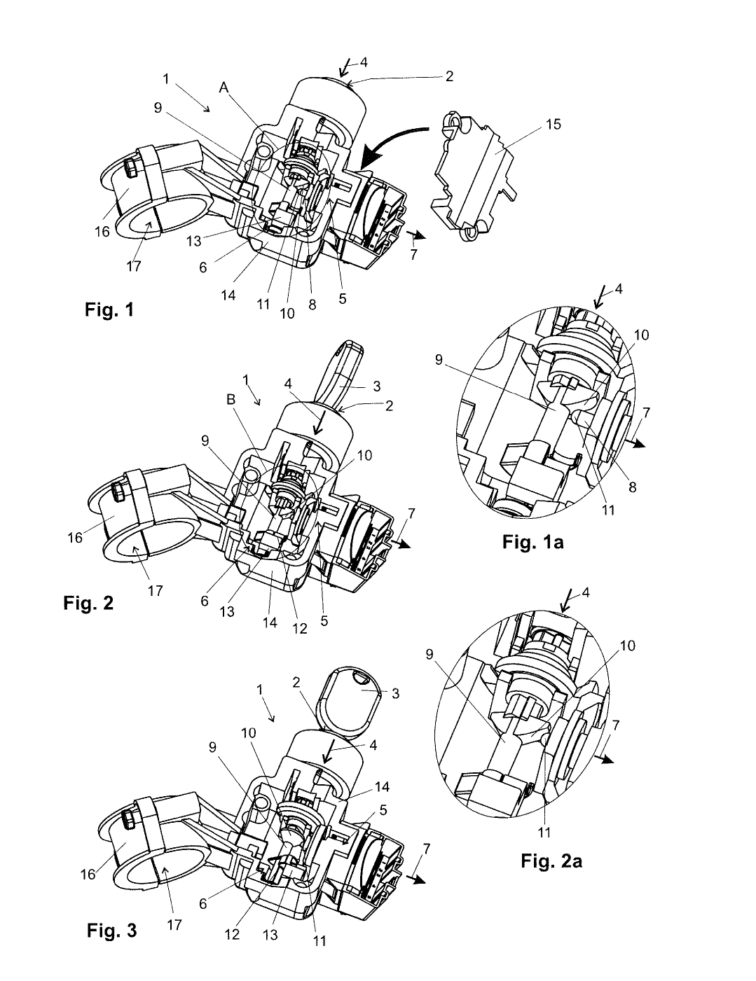

FIG. 1 the steering-wheel lock before the key is introduced into the key receptacle;

FIG. 1a region A from FIG. 1, enlarged;

FIG. 2 the steering-wheel lock according to FIG. 1 with key inserted but not yet rotated;

FIG. 2a region B from FIG. 2;

FIG. 3 the steering-wheel lock after actuation of the blocking device;

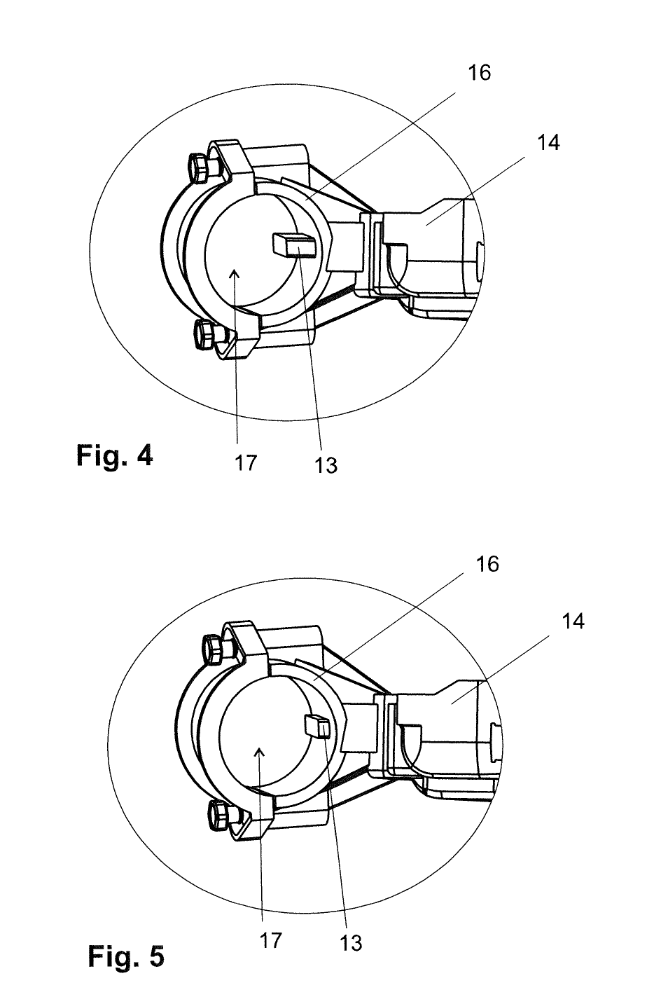

FIG. 4 the position of the blocking bolt of this embodiment in the blocking position of the blocking device and

FIG. 5 the blocking bolt in the release position.

The steering-wheel lock 1 represented here exhibits a housing 14, the cover 15 of which has been removed in all the figures, in order that it is possible to look into the interior of the steering-wheel lock 1. In all the figures the key receptacle 2 is concealed and not immediately visible, but has been constructed so as to be adapted to the respective key, as known in the state of the art. The key 3 can in any case be inserted into the key receptacle 2 in the insertion direction 4. In FIG. 1 the key has not yet been inserted into the key receptacle 2. The switching element 8 has emerged from the electrical switch 5 contrary to the switching direction 7, still in its maximally extended position, so that the switching contact has not yet been closed. In this position there may, for example, be provision that all the circuits have been interrupted. The blocking bolt 13 of the blocking device 6 in this position is located in its blocking position represented in FIG. 4, in which it engages into the steering spindle, not represented here, which has been guided through the feed-through opening 17 of the clip 16, and in this way prevents a steering movement from being carried out on the steering spindle or on the steering wheel. If the key 3 is now inserted into the key receptacle 2 in the insertion direction 4, then by this means the actuating element 9, which in this embodiment bears a conical inclined surface 10, is displaced a little way in the insertion direction 4 together with the inclined surface 10. This is favorably effected whenever the key is inserted into the key receptacle 2 over its first partial distance. The rounded contact region 11 of the switching element 8, which here is pin-shaped, abuts the inclined surface 10. As a result of the displacing of the inclined surface 10 in the insertion direction 4, the switching element 8 is moved in the switching direction 7 (compare FIGS. 1 and 1a with 2 and 2a), as a result of which the electrical switch 5 switches on, for example, the circuits provided for it. Here it may be a question, for example, of a circuit for the radio or for other comfort functions of the motor vehicle. The interacting of inclined surface 10 and contact region 11 can be seen particularly well in the enlarged representations shown in FIGS. 1a and 2a. Of course, the contact region 11 could also exhibit an inclined surface instead of a rounding. There could also be provision that the inclined surface is arranged on the switching element 8, and the contact region 11 on the actuating element 9, or that they are at least moved jointly with these elements in the respective directions of motion 4 and 7. These, of course, are only some possible variations of the invention in comparison with the embodiment represented here. If, as represented in FIG. 2, the key 3 is then completely inserted into the key receptacle 2 but not yet rotated around the insertion direction 4, then, although the desired circuits have already been supplied with current by the electrical switch 5, the blocking device 6 is still located in its blocking position. If, in the embodiment shown, the key 3 is now rotated around the insertion direction 4 out of the position according to FIG. 2 into the position according to FIG. 3, then the blocking device 6 in the embodiment shown is brought out of its blocking position into its release position. In the release position the blocking bolt 13 is retracted, as can be seen in FIG. 5. In this release position said bolt is not in engagement with the steering spindle, not represented here, which has been guided through the feed-through opening 17 of the clip 16. In this release position the steering spindle can then be rotated about its longitudinal axis for the purpose of carrying out steering movements.

For the purpose of actuating the blocking bolt 13, in the embodiment shown a cam 12 rotating together with the key 3 via the actuating element 9 has been realized, which displaces the blocking bolt 13 to and fro between the blocking position according to FIGS. 2 and 4 and the release position according to FIGS. 3 and 5, depending on the direction of rotation of the key. Of course, the blocking device 6 may also have been realized quite differently. There does not even have to be provision that a twisting of the key 3 around the insertion direction 4 is necessary in order to actuate the blocking device 6. It is also conceivable to actuate the blocking device 6 by a sliding movement of the key 3 in, or contrary to, the insertion direction 4.

In the course of the twisting of the key 3 around the insertion direction 4 from the blocking position according to FIGS. 2 and 4 in the direction of the release position according to FIGS. 3 and 5 the switching element 8 can be displaced still further in the switching direction 7, so that further switching functions can be realized in the electrical switch 5. To this end, and for this case, the inclined surface 10 is additionally overlaid by a cam contour which imposes this travel in the course of the twisting of the key 3. The inclined surface is then not conical but helical.

With advantage, the inclined surface which, viewed in cross section in relation to the insertion direction 4, runs substantially approximately along the angle bisector between the insertion direction 4 and the switching direction 7, is formed from hardened steel or with a ceramic coating, or from ceramic. The contact region 11 of the switching element 8 is preferably formed from hardened steel or from a ceramic coating. The contact element may preferably be coated with a DLC layer or an ADLC layer.

The contact element 8 is preferably biased in the direction of the inclined surface 10 with a spring, in which case the last opening stroke in the switching direction 7 is, with advantage, designed with at least slighter biasing or entirely without biasing. The spring tension and the spring travel accordingly just suffice to open the switching contact in the electrical switch 5. On the inclined surface 10 a surface contour is, with advantage, formed which is partly undulatory, so that immediately at the beginning of the movement of the switching element 8 in the switching direction 7 the switching element is subjected to a slight reciprocating motion in the switching direction 7, in order better to overcome the initial static friction.

It is conceivable and possible to incorporate individual resistances into the movement of the key 3 in the insertion direction 4, so that a completely uniform insertion of the key 3 is rendered difficult. By virtue of these non-uniformities, the switching element 8 is moved non-uniformly in the switching direction 7, as a result of which a tendency to jam is reduced. In this connection it is conceivable and possible to combine the wavy shape in the inclined surface with the formation of resistances.

For the sake of completeness, let it also be pointed out that the switching of the ignition on and off by means of the key 3 and the steering-wheel lock 1 can also be realized, for example, both by rotating the key 3 around the insertion direction 4 and by inserting the key 3 in the insertion direction or contrary to the insertion direction 4. This does not need to be elucidated in any more detail, since this is known in the state of the art.

### LEGEND FOR THE REFERENCE NUMERALS

1 steering-wheel lock
2 key receptacle
3 key
4 insertion direction
5 electrical switch
6 blocking device
7 switching direction
8 switching element
9 actuating element
10 inclined surface
11 contact region
12 cam
13 blocking bolt
14 housing
15 cover
16 clip
17 feed-through opening

1.-10. (canceled)

11. A steering-wheel lock comprising:
a key receptacle for receiving a key in an insertion direction;
at least one electrical switch to be actuated upon insertion of the key into the key receptacle in the insertion direction, the at least one electrical switch including a switching element that is displaceable in at least one switching direction; and
at least one blocking device for selectively blocking a steering spindle, the at least one blocking device being selectively actuatable by the key,
wherein the insertion direction and the at least one switching direction are positioned at an angle relative to one another.

12. The steering-wheel lock of claim 11 wherein the insertion direction and the at least one switching direction are orthogonal to one another.

13. The steering-wheel lock of claim 11 further comprising:
at least one actuating element that is moved in the insertion direction when the key is inserted into the key receptacle; and
at least one inclined surface that is oblique relative to one or more of the insertion direction or the at least one switching direction, wherein the at least one actuating element engages the switching element via the at least one inclined surface.

14. The steering-wheel lock of claim 13 wherein at least some regions of the at least one inclined surface are formed as a conical shell.

15. The steering-wheel lock of claim 13 wherein one or more of the at least one actuating element or the switching element includes a contact region for interacting with the at least one inclined surface, with the contact region being at least partially rounded.

16. The steering-wheel lock of claim 13 wherein the at least one inclined surface is part of the at least one actuating element or is moved together with the at least one actuating element in the insertion direction.

17. The steering-wheel lock of claim 15 wherein the contact region is part of the switching element or is at least moved together with the switching element in the at least one switching direction.

18. The steering-wheel lock of claim 11 wherein the switching element is pin-shaped.

19. The steering-wheel lock of claim 11 wherein the insertion direction and the at least one switching direction are linear.

20. The steering-wheel lock of claim 11 wherein the at least one blocking device comprises at least one blocking bolt for engaging the steering spindle, wherein the at least one blocking bolt is displaceable by a rotatable cam.
